(19) United States
(12) Patent Application Publication
(10) Pub. No.: US 2020/0241816 A1
(43) Pub. Date: Jul. 30, 2020

(54) IMAGE FORMING APPARATUS AND IMAGE FORMING METHOD

(71) Applicant: KONICA MINOLTA, INC., Tokyo (JP)

(72) Inventor: Ken MIYAZAKI, Sagamihara-shi (JP)

(73) Assignee: KONICA MINOLTA, INC., Tokyo (JP)

(21) Appl. No.: 16/736,978

(22) Filed: Jan. 8, 2020

(30) Foreign Application Priority Data
Jan. 28, 2019 (JP) 2019-011847

(51) Int. Cl. G06F 3/12; B41F 17/10

(52) U.S. Cl. CPC G06F 3/1254; B41F 17/10

(57) ABSTRACT

An image forming apparatus includes: a printer that prints a plurality of images in a state where the plurality of images are divided in a plurality of lanes on a continuous sheet, the plurality of lanes respectively corresponding to the plurality of images; an inspector that reads each of the plurality of images printed on the continuous sheet and conducts an inspection; and a hardware processor that controls the printer to reprint an image that has been detected to be abnormal on the continuous sheet on which the image that has been detected to be abnormal has been printed, in a case where any of the plurality of images has been detected to be abnormal in the inspection conducted by the inspector.

The entire disclosure of Japanese patent Application No. 2019-011847, filed on Jan. 28, 2019, is incorporated herein by reference in its entirety.

### BACKGROUND

### Technological Field

The present invention relates to an image forming apparatus and an image forming method, and in particular, a technique that is suitable to be applied to a case where labels are printed.

### Description of the Related Art

A variety of image forming apparatuses that perform label printing have been practically used. Labels are formed by printing label images on a surface of label paper with release paper. After the label images are printed, each of the label images is cut out from the label paper by using a cutter blade that matches a shape of the label, so that the labels are completed.

In a case where label printing is performed, in order to improve the efficiency of printing and reduce a cost, plural different types of labels are simultaneously printed so as to be arranged on one sheet of roll paper (continuous form paper) in some cases. For example, as illustrated in FIG. 4A, one sheet of continuous form paper 10 is prepared, and three types of label images 11, 12, and 13 are printed so as to be arranged in a plurality of lanes in a primary scanning direction of the continuous form paper 10 (a direction of a lateral width W10). In the description below, roll-shaped paper (roll paper) on which printing is performed by an image forming apparatus is referred to as continuous form paper. The continuous form paper is long printing paper that is used for printing in an image forming apparatus called a continuous form type label printer or the like.

As each of the label images 11, 12, and 13, the same label image may be repeatedly printed, or each label image that changes in the content such as a serial number may be printed (what is called variable printing).

Then, the continuous form paper 10 on which the label images 11 to 13 have been printed is cut in positions in which the respective label images 11, 12, and 13 have been printed. Stated another way, the continuous form paper 10 on which the label images 11, 12, and 13 have been printed is cut into three sheets, so that continuous form paper 10a on which the label image 11 has been consecutively printed, continuous form paper 10b on which the label image 12 has been consecutively printed, and continuous form paper 10c on which the label image 13 has been consecutively printed are obtained, as illustrated in FIGS. 4B to 4D. Lateral widths W11, W12, and W13 of respective sheets of continuous form paper 10a, 10b, and 10c are set according to the sizes of the label images 11, 12, and 13.

As described above, printed sheets of continuous form paper 10a, 10b, and 10c are formed on which a necessary number of label images 11, 12, or 13 have been printed, and these printed sheets of continuous form paper 10a, 10b, and 10c are delivered to an order source. The label paper with release paper is relatively expensive. Printing a large number of labels on one sheet of continuous form paper, as illustrated in FIG. 4A, can contribute to a reduction in a printing cost.

JP 2017-177358 A describes a technique for performing defect detection after printing and reprinting a printed matter that has been detected to be defective, in variable printing.

Meanwhile, in delivering printed labels, as illustrated in FIGS. 4A to 4D, to an order source, in general, a slightly larger number of labels than is necessary are printed and delivered. By printing and delivering a larger number of labels than is necessary, as described above, even in a case where some label images have a defect such as a stain, substitutes for defective labels can be secured.

Here, in the case of variable printing for forming respective labels on which numbers or the like that are different from each other have been printed, it is requested that the same label as a label having a defect be reprinted. Accordingly, measures fail to be taken by simply increasing the number of labels to be printed. In such a case, measures can be taken against defects by inspecting a printed matter obtained by performing variable printing, by using an inspection apparatus, and reprinting a printed matter that has been detected to be defective, as described, for example, in JP 2017-177358 A.

In an actual printing process, plural types of labels that have been ordered from order sources different from each other are often printed together, as described above with reference to FIGS. 4A to 4D. In such a case, after printing has been performed on continuous form paper, only a label that has been detected to be defective is reprinted on another sheet of continuous form paper.

However, in a case where only the label that has been detected to be defective is reprinted on another sheet of continuous form paper, labels to be delivered to an order source are divided into continuous form paper including normal labels that have been first printed and continuous form paper including reprinted labels. Therefore, when printed labels are delivered to an order source, it is requested that it be confirmed whether the same type of label has been printed on the continuous form paper including the normal labels that have been first printed and the continuous form paper including the reprinted labels, and that an accident be avoided in which different types of labels are erroneously delivered to the order source.

In addition, only a label of a type that has been detected to be defective is printed on continuous form paper for reprinting. Therefore, a large margin part is generated, and printing is performed in a mode of generating a large useless space.

### SUMMARY

It is an object of the present invention to provide an image forming apparatus and an image forming method that are capable of solving a problem, such as erroneous delivery at the time of reprinting a defective image, in a case where labels or the like are printed on a continuous sheet such as continuous form paper.

To achieve the abovementioned object, according to an aspect of the present invention, an image forming apparatus reflecting one aspect of the present invention comprises: a printer that prints a plurality of images in a state where the plurality of images are divided in a plurality of lanes on a continuous sheet, the plurality of lanes respectively corresponding to the plurality of images; an inspector that reads each of the plurality of images printed on the continuous sheet and conducts an inspection; and a hardware processor that controls the printer to reprint an image that has been detected to be abnormal on the continuous sheet on which the image that has been detected to be abnormal has been printed, in a case where any of the plurality of images has been detected to be abnormal in the inspection conducted by the inspector, wherein the hardware processor controls the printer to reprint the image in a lane position that is identical in a primary scanning direction of the continuous sheet to a lane position of the image that has been detected to be abnormal.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram illustrating an example of an image forming apparatus according to an embodiment of the present invention;

FIG. 2 is a block diagram illustrating a processing configuration of an image forming apparatus according to an embodiment of the present invention;

FIG. 3 is a block diagram illustrating a control configuration of an image forming apparatus according to an embodiment of the present invention;

FIGS. 4A to 4D are diagrams illustrating an example in which images have been printed on continuous form paper by using an image forming apparatus according to an embodiment of the present invention;

FIG. 5 is a diagram illustrating an example of processing of cutting out images that have been printed on continuous form paper, by using a rotary cutter;

FIG. 6 is a diagram illustrating an example in which images have been printed on continuous form paper by using an image forming apparatus according to an embodiment of the present invention (an example of variable printing);

FIG. 7 is a flowchart illustrating an example of inspection processing according to an embodiment of the present invention;

FIG. 8 is a diagram illustrating an example in which some images have been detected to be abnormal in inspection processing according to an embodiment of the present invention;

FIG. 9 is a flowchart illustrating an example of recovery data generation processing according to an embodiment of the present invention;

FIG. 10 is a diagram illustrating an example of print data that has been generated from recovery data according to an embodiment of the present invention;

FIG. 11 is a flowchart illustrating an example of reprinting processing according to an embodiment of the present invention;

FIG. 12 is a diagram illustrating an example of a printing state after reprinting (Example 1: an example in which an interval has been generated) according to an embodiment of the present invention; and

FIG. 13 is a diagram illustrating an example of a printing state after reprinting (Example 2: an example in which a partition line has been generated) according to an embodiment of the present invention.

### DETAILED DESCRIPTION OF EMBODIMENTS

Hereinafter, one or more embodiments of the present invention (hereinafter referred to as the “present embodiment”) will be described with reference to the drawings. However, the scope of the invention is not limited to the disclosed embodiments.

[1. Configuration Example of Image Forming Apparatus]

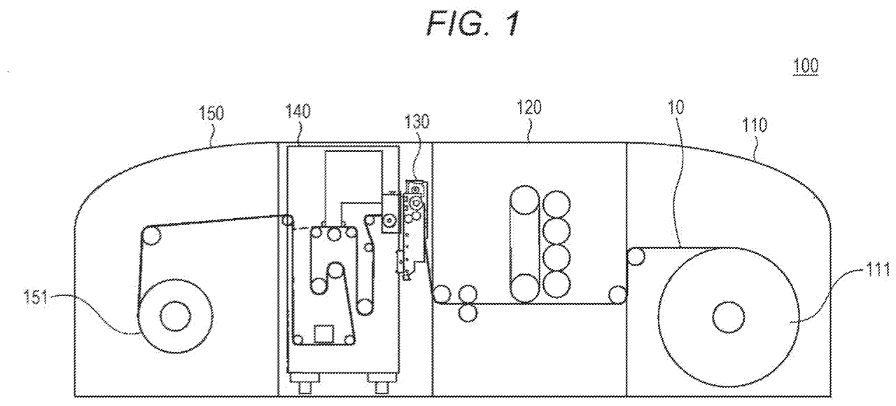

FIG. 1 illustrates a configuration example of an image forming apparatus 100 according to the present embodiment.

The image forming apparatus 100 includes a paper feeder 110, a printer 120, a cutter 130, an inspector 140, and a paper ejector 150.

The paper feeder 110 includes a continuous form paper roll 111, and continuous form paper 10 that has been pulled out from the continuous form paper roll 111 is fed to the printer 120. The continuous form paper 10 is long printing paper (roll paper). Continuous form paper serving as roll paper has been used above as printing paper, but this is an example. Printing paper does not always need to be paper that has been wound in a roll shape.

Stated another way, continuous paper (a continuous sheet) in which paper having a fixed size is continuous may be used for printing. In addition, the continuous form paper described here does not need to be what is called business form paper, and various sheets of paper on which the label printing described next can be performed can be applied. Further, the continuous form paper described here also includes printing paper that uses a printing medium other than paper (such as a film or cloth).

Accordingly, in addition to the continuous form paper 10 described as an example, a variety of continuous sheets on which label printing can be continuously performed can be applied to printing paper (a printing medium) that is used for printing by the image forming apparatus 100 according to the present embodiment.

A printer engine that performs color printing is disposed in the printer 120, and this printer 120 performs printing processing for forming an image on a surface of the continuous form paper 10. The image that is formed on the surface of the continuous form paper 10 in the printing processing performed by the printer 120 according to the present embodiment is a label image, and a set number of label images are repeatedly printed. In addition, label images different from each other coexist in a primary scanning direction (a lateral width direction of the continuous form paper 10) at the time of printing performed by the printer engine. Stated another way, respective label images are repeatedly printed in a plurality of lanes that have been set in the lateral width direction of the continuous form paper 10. Then, the continuous form paper 10 on which the label images have been printed by the printer 120 is fed to the cutter 130.

The cutter 130 cuts, in arbitrary positions, the continuous form paper 10 on which the label images have been continuously printed. Cutting is performed along a direction of movement (a longitudinal direction) of the continuous form paper 10. The cutter 130 performs processing for separating label images for each type (processing for separating label images for each lane). The continuous form paper 10 on which cutting has been performed by the cutter 130 is fed to the inspector 140.

The inspector 140 includes a scanner that reads the surface of the continuous form paper 10. The inspector 140 compares label images read by the scanner with label images that have been prepared in advance so as to determine the presence/absence of an abnormality such as a stain. Then, the continuous form paper 10 on which the label images have been read by the scanner of the inspector 140 is fed to the paper ejector 150. The paper ejector 150 includes a continuous form paper roll 151, and winds up the printed continuous form paper 10.

[2. Internal Configuration of Image Forming Apparatus]

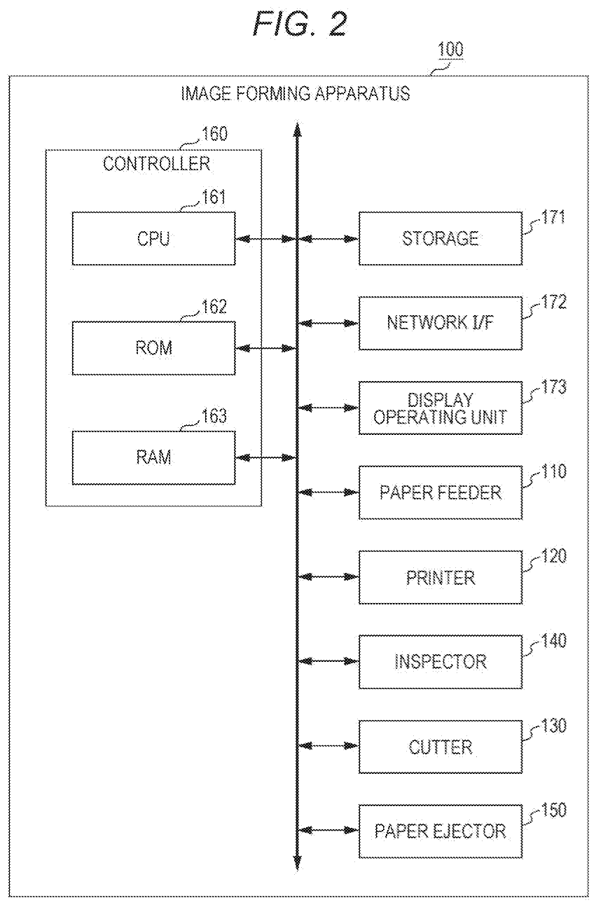

FIG. 2 illustrates an internal configuration of the image forming apparatus 100.

The image forming apparatus 100 includes a controller 160, a storage 171, a network interface 172, and a display operation unit 173 in addition to the paper feeder 110, the printer 120, the cutter 130, the inspector 140, and the paper ejector 150 that have been described with reference to FIG. 1.

The controller 160 includes a central processing unit (CPU) 161, a ROM 162, and a RAM 163. The CPU 161 reads a program stored in the ROM 162, executes the program, and controls respective units of the image forming apparatus 100. Stated another way, the controller 160 controls printing processing performed by the printer 120, inspection conducted by the inspector 140, and the like. Data that is used for the controller 160 to perform control is stored in the ROM 162.

The storage 171 stores image data according to which the image forming apparatus 100 will perform printing, various types of setting data in printing, data of an inspection result, and the like. As this storage 171, a hard disk drive, a non-volatile semiconductor memory, or the like is used.

The network interface 172 performs communication with external equipment. For example, the network interface 172 receives, from external equipment, label image data according to which printing will be performed. In addition, when an abnormality has occurred in the image forming apparatus 100, the network interface 172 reports the abnormality in the image forming apparatus 100 to a center that manages the image forming apparatus 100.

The display operation unit 173 includes a display panel and a touch panel. The display operation unit 173 performs processing for making a report to a user that operates the image forming apparatus 100 and processing for receiving an operation performed by the user. For example, on the display panel, buttons that enable an operation to set a printing state, an operation to start and stop printing, and other operations are displayed. When it has been detected that a button has been operated on the touch panel, a function that has been allocated to the button is executed under the control of the controller 160.

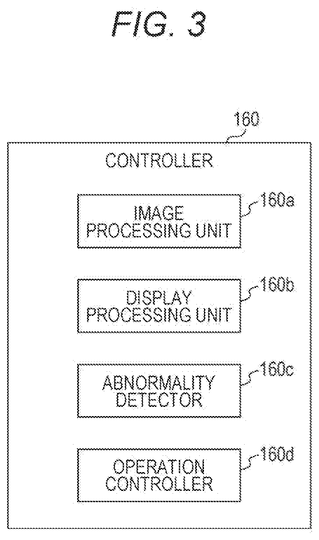

FIG. 3 is a functional block diagram from the viewpoint of functions executed by the controller 160. The controller 160 includes an image processing unit 160a, a display processing unit 160b, an abnormality detector 160c, and an operation controller 160d. The image processing unit 160a, the display processing unit 160b, the abnormality detector 160c, and the operation controller 160d described above are formed by executing a program (software) stored in the ROM 162 (FIG. 2).

The image processing unit 160a converts label image data that has been externally input and is used to perform printing into image data for printing that is called raster image processor (RIP) data, and transmits the converted image data for printing to the printer 120. In addition, when variable printing is performed to form labels including serial numbers different from each other, or the like, the image processing unit 160a generates image data for each of the labels.

Further, the partition line described later that is used at the time of reprinting is added to printed images in processing performed by the image processing unit 160a.

The display processing unit 160b performs processing for generating an image to be displayed on the display panel included in the display operation unit 173. For example, the display processing unit 160b performs processing for displaying printing setting performed on the image forming apparatus 100, a printing execution state, and the like. The display processing unit 160b also performs processing for displaying an operation button that is used to receive an operation on the touch panel.

The abnormality detector 160c compares an image read by the inspector 140 with an image having a cited-document function that has been prepared in advance, and determines whether the printed image has an abnormality. In a case where the abnormality detector 160c detects an abnormality, the abnormality detector 160c issues an instruction of reprinting or the like to the printer 120.

The operation controller 160d controls a printing operation performed on the continuous form paper 10 by the printer 120 and an inspection operation performed by the inspector 140. The operation controller 160d also controls an operation to feed the continuous form paper 10 performed by the paper feeder 110 and a winding-up operation performed by the paper ejector 150 in conjunction with the printing operation performed by the printer 120, and controls a cutting operation performed by the cutter 130.

[3. Example of Printing State]

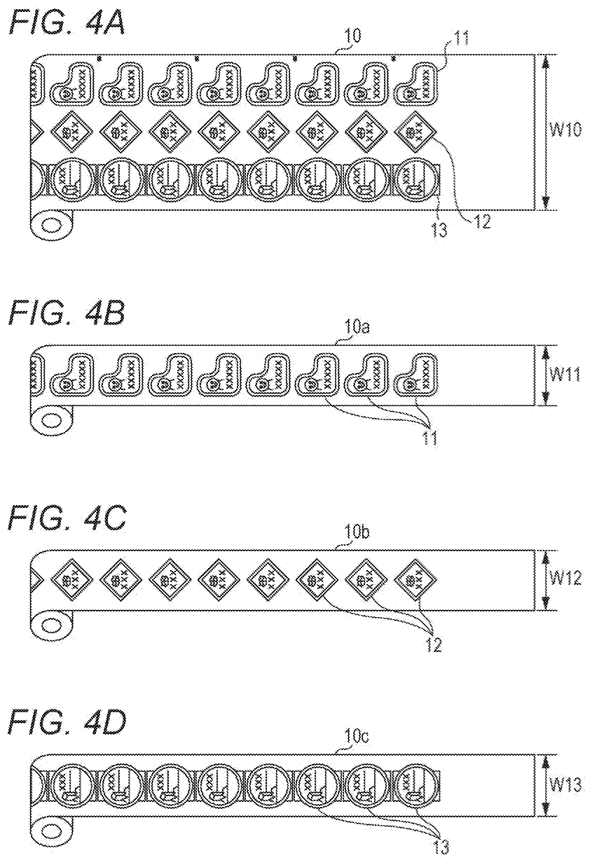

FIGS. 4A to 4D illustrate examples of a state where the image forming apparatus 100 according the present embodiment prints label images on the continuous form paper 10.

As already described, the image forming apparatus 100 according to the present embodiment prints three types of label images 11, 12, and 13 in such a way that the label images 11, 12, and 13 are arranged in a primary scanning direction (a direction of a lateral width W10) of one sheet of continuous form paper 10 so as to be divided in a plurality of lanes (here, three lanes), as illustrated in FIG. 4A. Here, it is assumed that, as each of the label images 11, 12, and 13, the same label image is repeatedly printed. Each of the label images 11, 12, and 13 is repeatedly printed in the same lane position in a primary scanning direction at the time of performing printing on the continuous form paper 10 (a lateral width direction of the continuous form paper 10).

Then, the cutter 130 of the image forming apparatus 100 cuts the continuous form paper 10 on which the label images 11 to 13 have been printed in a longitudinal direction of the continuous form paper 10 in positions at boundaries among printing positions of the respective label images 11, 12, and 13 (at boundaries among lanes), and the cutter 130 divides the continuous form paper 10 on which the label images 11, 12, and 13 have been printed into three sheets.

Specifically, as illustrated in FIGS. 4B to 4D, continuous form paper 10a on which the label image 11 has been printed, continuous form paper 10b on which the label image 12 has been printed, and continuous form paper 10c on which the label image 13 has been printed are obtained. When the cutter 130 performs cutting, lateral widths W11, W12, and W13 of respective sheets of continuous form paper 10a, 10b, and 10c are set according to the sizes of the label images 11, 12, and 13 to be printed. Then, the sheets of continuous form paper 10a to 10c on which the respective label images 11 to 13 have been printed are delivered to order sources of respective labels.

As illustrated in FIG. 4A, three types of label images 11, 12, and 13 are printed on one sheet of continuous form paper 10 so as to be arranged side by side, but this is an example. The image forming apparatus 100 may arrange and print a certain number of types of label images that is not three. For example, the image forming apparatus 100 may arrange and print two types of label images, or may arrange and print four or more types of label images.

[4. Example of Label Cutting-Out Process]

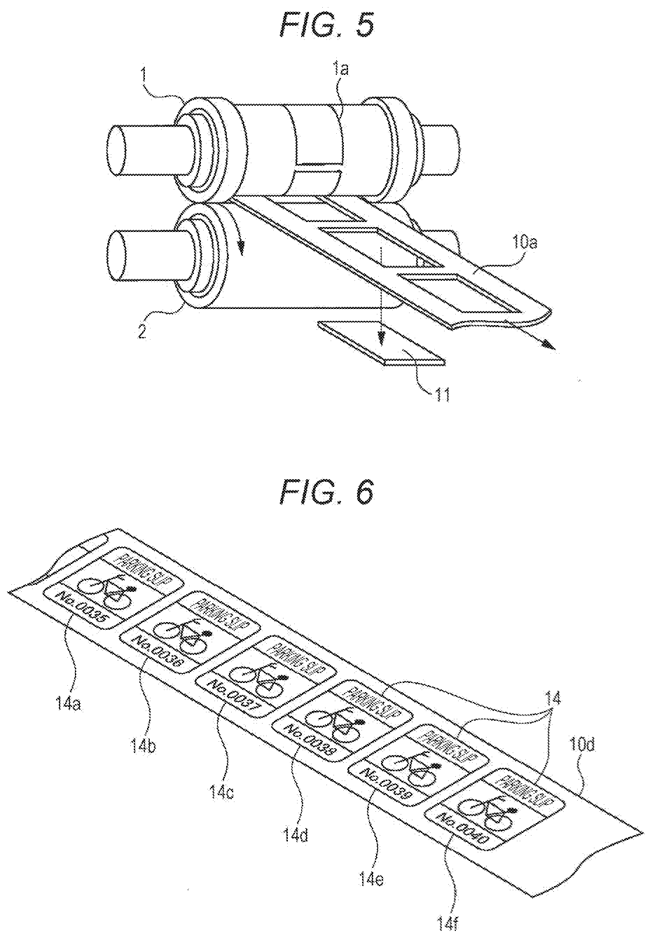

FIG. 5 illustrates an example of a label cutting-out process for cutting out label images that have been formed on the sheets of continuous form paper 10a to 10c illustrated in FIGS. 4B to 4D.

As illustrated in FIG. 5, in the label cutting-out process, a die cutter 1 is prepared. The die cutter 1 is attached with a cutter blade 1a that matches a size of the label image 11 to be cut out. This die cutter 1 is disposed in a position facing an anvil roll 2.

As illustrated in FIG. 5, continuous form paper 10 on which the label image 11 has been printed at fixed intervals is caused to pass between the die cutter 1 and the anvil roll 2, so that each of the label images 11 is cut out by using the cutter blade 1a, and the cut-out label images 11 are stuck in predetermined positions.

[5. Example of Variable Printing]

In the examples illustrated in FIGS. 4A to 4D, the same image is repeatedly printed so that a necessary number of label images 11, 12, or 13 are formed. However, variable printing can also be performed, for example, in such a way that an individual number or the like is inserted into each label image.

Stated another way, an individual number may be inserted into each label image, as illustrated as label images 14a, 14b, 14c, . . . that are formed on continuous form paper 10d in FIG. 6. The continuous form paper 10d illustrated in FIG. 6 is obtained by cutting the continuous form paper 10 in a longitudinal direction.

[6. Abnormality Detection Processing Performed by Image Forming Apparatus]

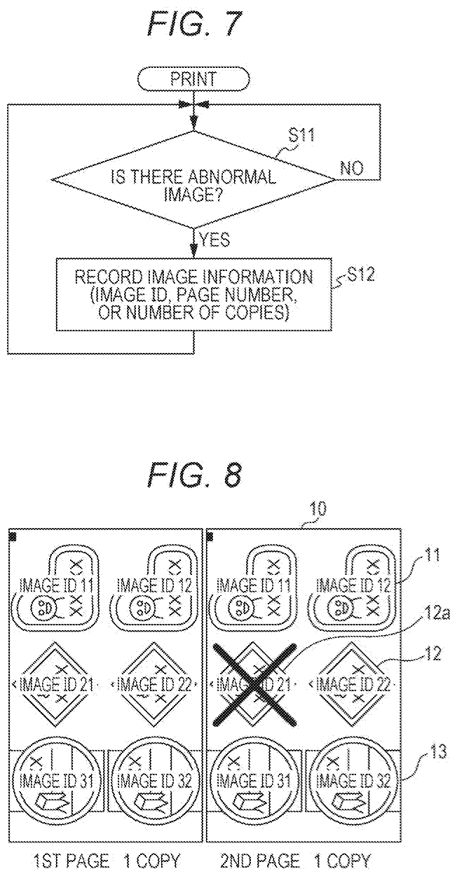

FIG. 7 is a flowchart illustrating a flow of abnormality detection processing at the time of printing performed by the image forming apparatus 100.

First, the abnormality detector 160c (FIG. 3) performs inspection processing for comparing an image read by the inspector 140 with an original image for printing that has been prepared in advance, and determines whether there is an abnormal image including a stain or the like (step S11). In a case where it is determined in step S11 that there are no abnormal images (NO in step S11), the processing returns to a comparison of a label image that has been printed next.

In a case where it is determined in step S11 that any of label images has an abnormality (YES in step S11), information relating to a label image that has been detected to be abnormal is recorded in the abnormality detector 160c (step S12), and the processing returns to the comparison of step S11 of a label image that has been printed next. Conceivable examples of the information recorded in step S12 relating to a label image that has been detected to be abnormal include an ID of the label image, a page number, the number of copies, and the like.

FIG. 8 illustrates an example in which an abnormality is detected in a label image printed on the continuous form paper 10.

Here, when the image forming apparatus 100 performs printing on the continuous form paper 10, it is assumed that printing processing is performed in units of a page allocated to each fixed length of the continuous form paper 10, and individual image IDs are given to the label images 11, 12, and 13 on each of the pages.

For example, as illustrated in FIG. 8, two sets of the label images 11, 12, and 13 are disposed on each page, and image ID 11 and image ID 12 are given to the two label images 11. In addition, image ID 21 and image ID 22 are given to the two label images 12, and image ID 31 and image ID 32 are given to the two label images 13.

Here, it is assumed that the abnormality detector 160c has detected an abnormality such as a stain in a label image 12a of image ID 21 on a second page (an image given the mark x in the drawing) on the basis of inspection conducted by the inspector 140.

The abnormality detector 160c that has detected such an abnormality first temporarily stores, for example, in the RAM 163 (FIG. 2), that the label image 12 of image ID 21 on the second page has an abnormality. Data indicating that an abnormality has been detected may be temporality stored in the RAM 163, or may be stored in the non-volatile storage 171 illustrated in FIG. 3.

[7. Printed Image Generation Processing Using Recovery Data that is Performed by Image Forming Apparatus]

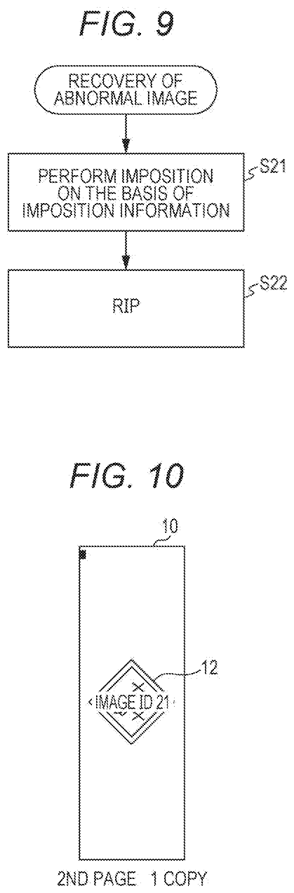

FIG. 9 is a flowchart illustrating a flow of printed image generation processing using recovery data that is performed by the image forming apparatus 100.

The printed image generation processing using recovery data that is performed by the image forming apparatus 100 is performed following pressrun performed by the image forming apparatus 100.

When there is an image that has been detected to be abnormal by the abnormality detector 160c at the time of printing, the processing of the operation controller 160d (FIG. 3) of the image forming apparatus 100 moves on to printed image generation processing using recovery data.

In this printed image generation processing, as illustrated in the flowchart of FIG. 9, the operation controller 160d causes the image processing unit 160a to perform imposition processing (arrangement processing) on a label image on one page at the time of reprinting on the basis of imposition information relating to the label image that has been detected to be abnormal (step S21). In this imposition processing performed on the label image, setting is performed in such a way that the label image is located in the same position as a position in the primary scanning direction (the lateral width direction) in which the label image that has been detected to be abnormal has been printed on the continuous form paper 10.

Then, the image processing unit 160a performs processing for converting an image of a page obtained by performing the imposition processing of step S21 into image data for printing that is called RIP data (step S22). The image data for printing obtained as described above is transmitted to the printer 120, and the printer 120 stands by until the start of reprinting.

FIG. 10 illustrates an example in which imposition processing has been performed on the label image 12 of image ID 21 for reprinting in a case where an abnormality has been detected in the label image 12 (the example of FIG. 8).

The example of FIG. 10 indicates a state where imposition processing has been performed in order to print the label image 12 of image ID 21. When an abnormality is not detected in the label image 11 or the label image 13, only this label image 12 of image ID 21 is arranged, and no label images are arranged in positions in which the label image 11 and the label image 13 have been arranged.

The imposition processing illustrated in FIG. 10 is an example. For example, in a case where an abnormality has been detected in the label image 11 and the label image 13, label images are arranged in positions in which these label images 11 and 13 have been arranged. Also in a case where recovery printing is performed on the label images 11 and 13, imposition processing is performed in such a way that the respective label images 11 and 13 are located in the same positions as positions in the primary scanning direction in pressrun.

In addition, at the time of printed image generation using recovery data, imposition processing for recovery printing may be performed in a state where a certain number of label images are added to label images having an abnormality.

[8. Reprinting Processing Performed by Image Forming Apparatus]

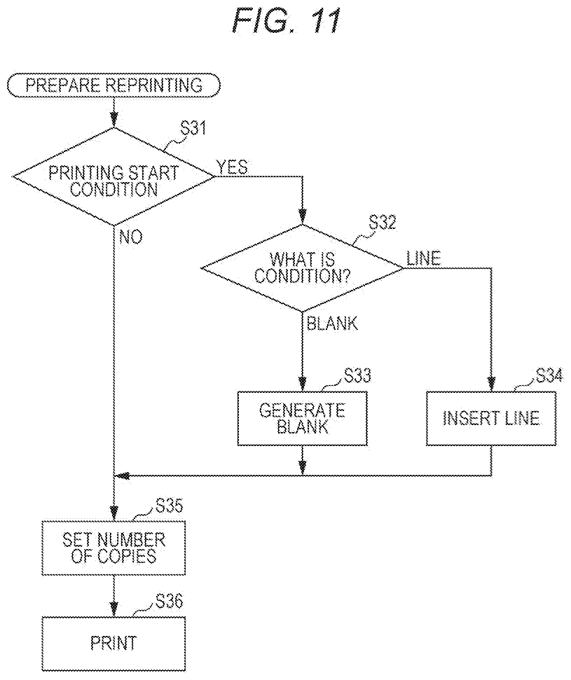

FIG. 11 is a flowchart illustrating a flow of reprinting processing performed by the image forming apparatus 100.

Reprinting processing performed by the image forming apparatus 100 is performed following the printed image generation processing illustrated in the flowchart of FIG. 9.

First, the operation controller 160d determines whether a printing start condition at the time of reprinting has been set (step S31). Here, in a case where the printing start condition has been set (“YES” in step S31), the operation controller 160d determines whether the set printing start condition is a condition of generating a blank or a condition of performing partitioning with a line (Step S32).

When it is determined in step S32 that the set printing start condition is the condition of generating a blank (“blank” in step S32), the operation controller 160d performs processing for generating a predetermined blank between a label image that has been most recently printed on the continuous form paper 10 in pressrun and a label image to be newly printed (step S33).

When it is determined in step S32 that the set printing start condition is the condition of performing partitioning with a line (“line” in step S32), the operation controller 160d performs processing for printing a partition line between a label image that has been most recently printed on the continuous form paper 10 in pressrun and a label image to be newly printed (step S34).

In a case where the printing start condition has not been set in step S31 (“NO” in step S31), after the processing of step S33 for generating a blank has been performed, and after the processing of step S34 for performing partitioning with a line has been performed, the operation controller 160d sets the number of reprint copies (step S35).

After the number of reprint copies has been set in step S35, the operation controller 160d causes the printer 120 to perform reprinting (step S36).

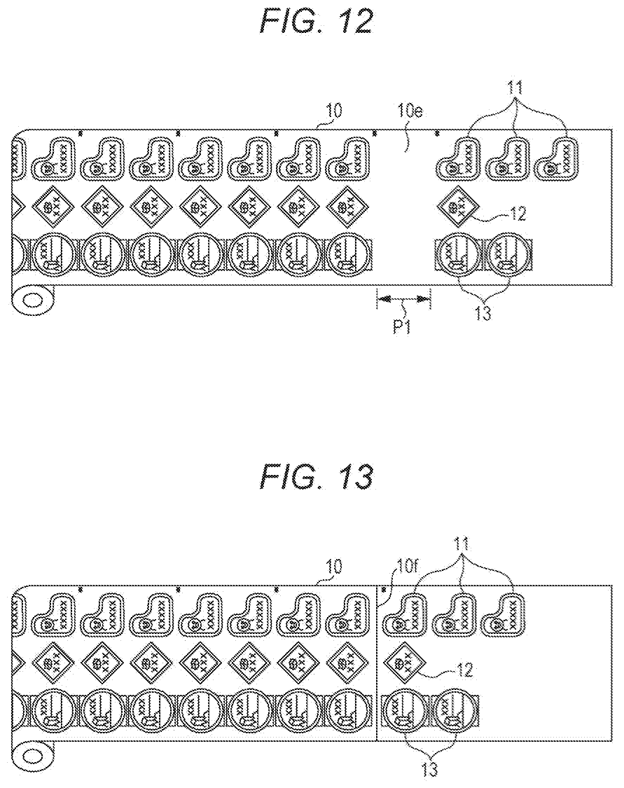

FIG. 12 illustrates an example of reprinting at a time when the condition of generating a blank has been set in step S32.

The example of FIG. 12 indicates an example in which three label images 11, one label image 12, and two label images 13 have been reprinted.

Here, the label images 11, 12, and 13 for reprinting have been reprinted so as to be spaced apart from the end of pressrun on the continuous form paper 10 by a predetermined blank 10e.

A length P1 of the blank 10e is assumed to be a predetermined distance. For example, when the printer 120 performs printing processing in units of one page, the blank 10e may be set to have a length P1 of one page. Alternatively, the length P1 of the blank 10e may be set to be a distance that is nearly equivalent to the size of one label image 11, 12, or 13.

By providing this blank 10e, reprinted label images are arranged after label images formed in pressrun so as to be spaced apart by an interval that is different from a usual interval, and the label images formed in pressrun can be clearly distinguished from label images formed in reprinting.

FIG. 13 illustrates an example of reprinting at a time when the condition of performing partitioning with a line has been set in step S32.

The example of FIG. 13 also indicates an example in which three label images 11, one label image 12, and two label images 13 have been reprinted.

Here, a line 10f is printed in the primary scanning direction (a width direction) of the continuous form paper 10 at the end of pressrun on the continuous form paper 10. Label images 11, 12, and 13 printed after the line 10f are reprinted label images.

When the line 10f illustrated in FIG. 13 is printed, it is preferable that an interval between the end of label images 11, 12, and 13 formed in pressrun and the head of label images 11, 12, and 13 formed in reprinting can maintain an interval at the time of printing respective label images 11, 12, and 13 in pressrun. Alternatively, in order to insert the line 10f, the interval between the end of the label images 11, 12, and 13 formed in pressrun and the head of the label images 11, 12, and 13 formed in reprinting may be set to be an interval that is different from a usual interval. In the case of the interval that is different from the usual interval, a relatively large interval, such as an interval of one page, may be set, as indicated in the example of FIG. 12.

As described above, by employing the image forming apparatus 100 according to the present embodiment, in a case where printing abnormality, such as a stain in an image, has occurred in printing label images on the continuous form paper 10, reprinting can be performed on the same continuous form paper 10 following pressrun on the basis of the detection of the printing abnormality. Here, in the case of the present embodiment, it has been assumed that a plurality of label images 11, 12, and 13 are printed together on one sheet of continuous form paper 10, as illustrated in FIGS. 4A to 4D.

The image forming apparatus 100 according to the present embodiment prints the plurality of label images 11, 12, and 13 together. Therefore, the image forming apparatus 100 performs processing for cutting the continuous form paper 10 after printing so as to separate the label images 11, 12, and 13 from each other. However, in reprinting, label images 11, 12, and 13 for reprinting are printed in the same positions in the primary scanning direction as positions in pressrun. Therefore, each of the sheets of continuous form paper 10a to 10c after cutting (FIGS. 4B to 4D) includes reprinted label images of the same type as the type of label images formed in pressrun.

Therefore, a cutting position of the cutter 130 does not need to be set again at the time of reprintings, and label images that have been reprinted on the same continuous form paper 10 can be delivered in a state where the reprinted label images follow label images formed in pressrun on the same paper. Thus, an accident can be reliably avoided in which respective reprinted label images 11, 12, and 13 are erroneously delivered to another agent.

Label images formed in pressrun and label images formed in reprinting are obtained in a clearly distinguishable manner, as illustrated in FIG. 12 or 13. Therefore, in a task of sticking delivered labels on products or the like, reprinted labels can be reliably recognized, and this enables an efficient label sticking task. Accordingly, by employing the image forming apparatus 100 according to the present embodiment, productivity of printing a plurality of label images is remarkably improved.

[9. Variations]

In the embodiment described above, a certain number of label images that is equal to the number of label images that have been detected to be abnormal by the abnormality detector 160c are reprinted. In contrast, a margin may be given to the number of label images to be reprinted by setting the number of label images to be reprinted to a number obtained by adding a fixed number to the number of label images having an abnormality. For example, setting may be performed in such a way that three sets of respective label images are normally reprinted, and the number of label images that have been detected to be abnormal may be added to the number of label images to be reprinted. Alternatively, a certain number of label images that is obtained by multiplying the number of label images that have been detected to be abnormal by a fixed ratio, for example, 2, may be reprinted.

In addition, a case where pressrun is variable printing, as illustrated in FIG. 6 can also be coped with. Stated another way, in variable printing, a label image that includes, for example, the same number as the number of a label image that has been detected to be abnormal is reprinted. Here, when setting is performed to reprint a certain number of label images that is twice the number of label images that have been detected to be abnormal, as described above, two sets of label images that respectively include, for example, the same numbers as numbers included in the label images that have been detected to be abnormal are reprinted.

Further, in the embodiment described above, the present invention has been applied to label production processing for printing label images on a surface of label paper with release paper. However, the present invention can also be applied to a case where plural types of images other than the label image are printed so as to form a large number of images. The continuous form paper 10 is an example of paper to be used in printing, as already described. A variety of continuous sheets can be employed.

Furthermore, the configuration illustrated in FIG. 1 of the image forming apparatus 100 indicates a preferred example, and the present invention can be applied to image forming apparatuses of various forms.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a printer that prints a plurality of images in a state where the plurality of images are divided in a plurality of lanes on a continuous sheet, the plurality of lanes respectively corresponding to the plurality of images;
an inspector that reads each of the plurality of images printed on the continuous sheet and conducts an inspection; and
a hardware processor that controls the printer to reprint an image that has been detected to be abnormal on the continuous sheet on which the image that has been detected to be abnormal has been printed, in a case where any of the plurality of images has been detected to be abnormal in the inspection conducted by the inspector,
wherein the hardware processor controls the printer to reprint the image in a lane position that is identical in a primary scanning direction of the continuous sheet to a lane position of the image that has been detected to be abnormal.

2. The image forming apparatus according to claim 1, wherein
the hardware processor performs control to not perform reprinting in a lane position that is different from the lane position that is identical in the primary scanning direction of the continuous sheet to the lane position of the image that has been detected to be abnormal.

3. The image forming apparatus according to claim 1, wherein
the hardware processor sets an image interval in a sub scanning direction of the continuous sheet to an interval that is different from a usual image printing interval, when the hardware processor causes the printer to perform reprinting.

4. The image forming apparatus according to claim 1, wherein
the hardware processor sets a number of images to be reprinted to a number that is greater than a number of images that have been detected to be abnormal, when the hardware processor causes the printer to perform reprinting.

5. The image forming apparatus according to claim 1, wherein
the hardware processor performs control to generate a fixed interval between an image to be reprinted on the continuous sheet by the printer and images that have been printed on the continuous sheet before reprinting.

6. An image forming method comprising:
printing a plurality of images in a state where the plurality of images are divided in a plurality of lanes on a continuous sheet, the plurality of lanes respectively corresponding to the plurality of images;
reading each of the plurality of images printed on the continuous sheet, and conducting an inspection; and
reprinting, in the printing, an image that has been detected to be abnormal on the continuous sheet on which the image that has been detected to be abnormal has been printed, in a case where any of the plurality of images has been detected to be abnormal in the inspection, and performing the reprinting in a lane position that is identical in a primary scanning direction of the continuous sheet to a lane position of the image that has been detected to be abnormal.
